(19) United States
(12) Patent Application Publication
(10) Pub. No.: US 2017/0131817 A1
(43) Pub. Date: May 11, 2017

(54) METHOD FOR DYNAMICALLY DETECTING THRESHOLD VALUE OF DISPLAYING STYLUS STROKE ON TOUCH PANEL

(71) Applicant: WALTOP INTERNATIONAL CORPORATION, Hsinchu City (TW)

(72) Inventors: A-Li WONG, Hsinchu City (TW); Chih-Hung HUANG, Hsinchu City (TW)

(21) Appl. No.: 14/934,080

(22) Filed: Nov. 5, 2015

(51) Int. Cl. G06F 3/041; G06F 3/038; G06F 3/044; G06F 3/0354

(52) U.S. Cl. CPC G06F 3/0414; G06F 3/03545; G06F 3/0383; G06F 3/044

(57) ABSTRACT

A method for dynamically detecting a threshold value of displaying stylus stroke on a touch panel is disclosed. First of all, a step of detecting an average value of a plurality of sampling values of legal zero-force sensing signal is performed. Then a step of determining the average value of the plurality of sampling values of legal zero-force sensing signal as a dynamic value of zero-force sensing signal is performed. Finally, a step of calculating a threshold value of force sensing signal by the dynamic value of zero-force sensing signal and an offset value of force sensing signal is performed.

### BACKGROUND OF RELATED ART

1. Technical Field

The present invention generally relates to a method for detecting a threshold value, and more particularly to a method for dynamically detecting a threshold value of displaying stylus stroke on a touch panel.

2. Description of Related Art

Capacitive touch input technology is the mainstream of the input technologies applied to the widely used touch panel. A typical capacitive touch panel includes substrates on which transparent electrode patterns are coated thereon. When a finger or a stylus touch or hover on the touch panel, coupling capacitance is formed between the finger or the stylus and the transparent electrode patterns because the finger or the tip of the stylus is a conductive to establish capacitive coupling with the transparent electrode patterns. Meanwhile, the capacitance of the electrode pattern under the finger or the stylus on the touch panel will change, thus the voltage or the current in the electrodes of the electrode patterns will change. By comparing a voltage difference between the electrode under the finger or the stylus and the adjacent electrodes, the coordinate of the finger or the stylus can be determined.

However, the fingers of user are not suitable for a more delicate writing input operation, such as the writing input operations with stroke thickness changes. Moreover, input operation by using user's fingers also lacks various functions. Thus a stylus instead of user's fingers is used to perform exquisite input operation upon a touch panel with a capacitive touch input function. The stylus can further allow user to depict lines with various stroke thicknesses on a touch panel. The stylus can also detect the force which a user applies upon the stylus against the touch panel.

The stroke thickness of a stylus displayed on the touch panel is a result of signals generated from a force sensing module of the stylus. The stroke thickness of a stylus displayed on a touch panel should be proportional to the force difference (corresponding to the tip-off state) applied on the tip of the stylus in an ideal condition. Moreover, the stroke of the stylus should display on the touch panel once the tip of the stylus contacts the touch panel in an ideal condition. However, due to various issues, such as physical or mechanical defects of force detection components of the stylus or unstable characteristics of a force sensor of the stylus, the stroke of the stylus might display on the touch panel before the tip of the stylus contacts the touch panel or the thickness of the stroke displayed on the touch panel is thinner than expected. Thus the invention provides a method for dynamically detecting a threshold value to compromise the above issues of displaying stylus stroke on a touch panel.

### SUMMARY

The invention provides a method for dynamically detecting a threshold value of displaying stylus stroke on a touch panel. The method comprises a step of detecting an average value of a plurality of sampling values of legal zero-force sensing signal; a step of determining the average value of the plurality of sampling values of legal zero-force sensing signal as a dynamic value of zero-force sensing signal; and a step of calculating a threshold value of force sensing signal by the dynamic value of zero-force sensing signal and an offset value of force sensing signal.

The invention also provide a stylus with functions of dynamically detecting a threshold value of force sensing signal for displaying stroke on a touch panel comprising a control unit with embedded non-transitory computer readable medium storing executable instructions for performing a method for dynamically detecting a threshold value of force sensing signal for displaying stroke on a touch panel comprising a step of detecting an average value of a plurality of sampling values of legal zero-force sensing signal; a step of determining the average value of the plurality of sampling values of legal zero-force sensing signal as a dynamic value of zero-force sensing signal; and a step of calculating a threshold value of force sensing signal by the dynamic value of zero-force sensing signal and an offset value of force sensing signal.

### BRIEF DESCRIPTION OF THE DRAWINGS

FIG. 1 shows a schematic diagram of a stylus 100 touching a touch panel 10 according one embodiment of the invention.

FIG. 2 shows a schematic diagram illustrating force sensing signal curves of a plurality of styluses.

FIG. 3 shows an enlarged portion of the force sensing signal curves shown in FIG. 2 depicting dynamically adjusting threshold values of force sensing signal for displaying stylus stroke.

FIG. 4 shows a schematic diagram illustrating dynamically detecting threshold value of displaying stylus stroke according one embodiment of the invention.

FIG. 5 shows a flow chart of method for dynamically detecting a threshold value of displaying stylus stroke on a touch panel according one embodiment of the invention.

### DETAILED DESCRIPTION

Embodiment of this invention will be described in detail below. However, in addition to as described below, and this invention can be broadly implemented in the other cases the purpose and scope of this invention is not affected by the application of qualified, claim after its prevail. Furthermore, to provide a description more clear and easier to understand the invention, the pieces within the schema and not in accordance with their relative size of drawing, compared to certain dimensions to other scales have been exaggerated; details not related nor completely drawn in part in order to schematic simplicity.

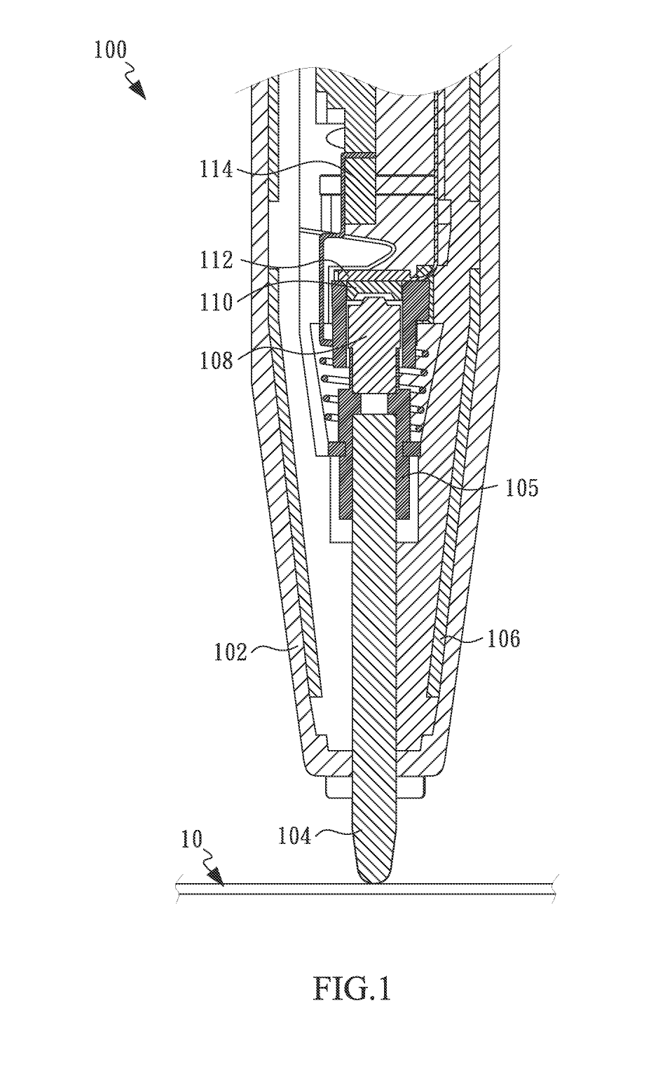

FIG. 1 shows a schematic diagram of a stylus 100 touching a touch panel 10 according one embodiment of the invention. The stylus 100 is utilized to perform exquisite input operation upon the touch panel 10. In this embodiment, the stylus 100 comprises a housing 102, a conductive nib 104, a nib holder 105, a shielding 106, an elastomer 108, a force sensor 110, a force sensor circuit board 112 and a control circuit board 114. The conductive nib 104 is configured to electrically couple to the control circuit board 114 and to establish capacitive coupling with transparent electrodes on the touch panel 10. The capacitances of the transparent electrodes on the touch panel 10 under the conductive nib 104 will change and voltages or currents in the electrodes will also change. The coordinates of the stylus 100 can thus be detected through changes of capacitances, voltages or currents in the electrodes.

In this embodiment, the conductive nib 104, the nib holder 105, the elastomer 108, the force sensor 110 and the force sensor circuit board 112 are configured to provide the stylus 100 with tip force detection. Some components can be further included to enhance the performance, such as a spring to restore the conductive nib 104 back to the original position after tip force is removed. In other embodiments, various force sensing modules can be used to provide the stylus 100 with tip force detection.

The stylus further comprises a control unit (not shown) on the control circuit board 114. The control unit comprises a microprocessor unit or MCU with embedded non-volatile memory or non-transitory computer readable medium such as flash memory. The control unit calculates the tip force applied on the stylus 100 via signals from the force sensor 110. The control unit outputs force sensing signals via the conductive nib 104 to the touch panel 10. The touch panel 10 displays strokes of the stylus 100 according to coordinates of the stylus 100 and stroke thicknesses according to force sensing signals. The stroke of the stylus 100 would be displayed on the touch panel 10 when the force sensing signals is over a default threshold value of force sensing signal once the conductive nib 104 contacts the touch panel 10.

The signals from the force sensor 110 may fluctuate due to various reasons. For example, physical and mechanical defects of the conductive nib 104, the nib holder 105, the elastomer 108 or the spring to restore the conductive nib 104, and the fluctuated contact condition between the elastomer 108 and the force sensor 110 amid the use of the stylus 100. The physical or mechanical defects of force sensing module may cause threshold value of force sensing signal fluctuates so that the stroke of the stylus 100 might be displayed on the touch panel 100 before the conductive nib 104 contacts the touch panel 10 or the thickness of the stroke displayed on the touch panel 10 is thinner than expected.

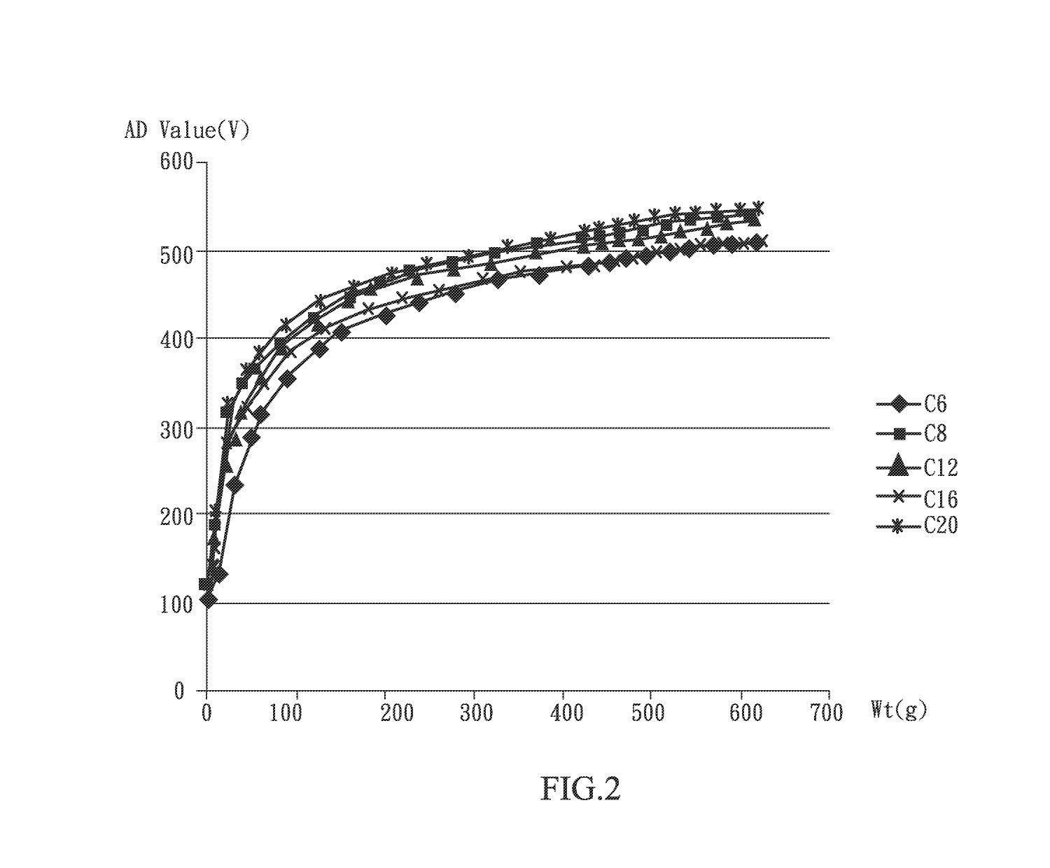

FIG. 2 shows a schematic diagram illustrating force sensing signal curves of a plurality of styluses. In this diagram, five styluses C6. C8, C12, C16 and C20 are applied with tip forces against a touch panel to generate force sensing signal curves. These force sensing signal curves show diversified force sensitivities of the styluses possibly due to the physical or mechanical defects of force sensing modules of styluses.

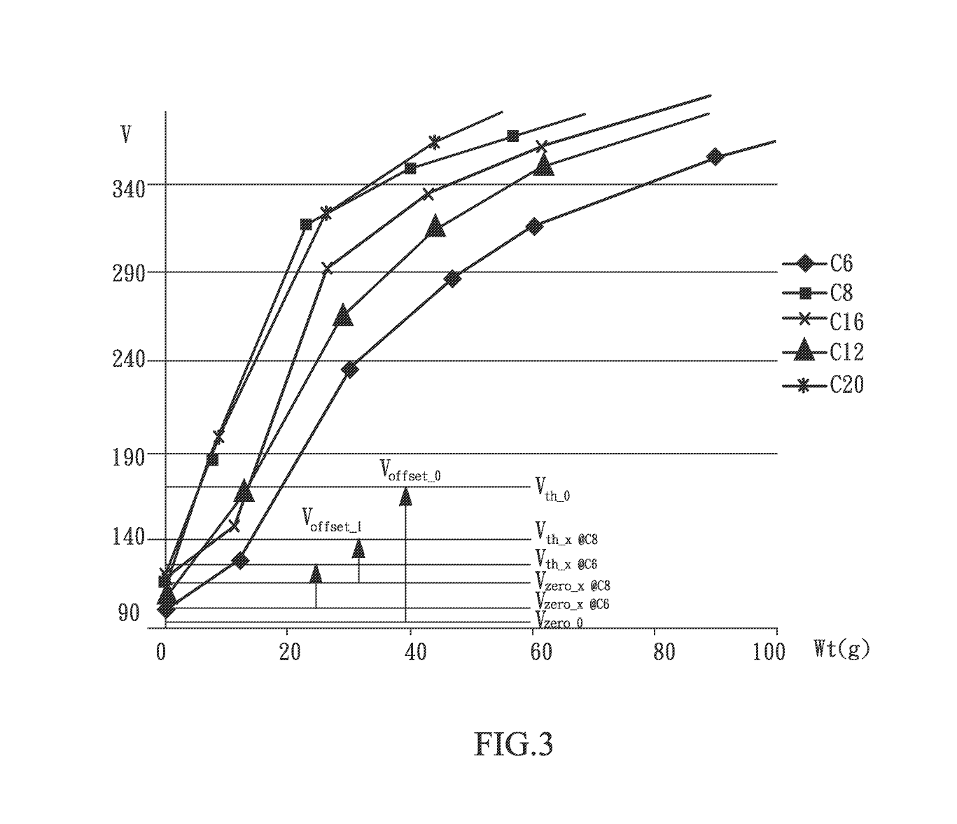

FIG. 3 shows an enlarged portion of the force sensing signal curves shown in FIG. 2 depicting dynamically adjusting threshold values of force sensing signal for displaying stylus stroke. In FIG. 3, schematic illustration of adjusting threshold values of force sensing signal of styluses C6 and C8 is shown. V_{zero}_{_}₀ is a default value of zero-force sensing signal for all styluses, while Vₜₕ_{_}₀ is a threshold value of force sensing signal to display stylus stoke on a touch panel for all styluses. The default value of zero-force sensing signal V_{zero}_{_}₀ plus an offset V_{offset}_{_}₀ equals the threshold value of force sensing signal Vₜₕ_{_}₀. For adjusting threshold values of force sensing signal of styluses C6 and C8, an offset V_{offset}_{_}₁ smaller than the offset V_{offset}_{_}₀ is used. V_{zero}_{_}ₓ is a dynamic value of zero-force sensing signal obtained by sampling and dynamic calculation. As shown in FIG. 3, each stylus may have different dynamic values of zero-force sensing signal V_{zero}_{_}ₓ due to various physical or mechanical characteristics. The dynamic value of zero-force sensing signal V_{zero}_{_}ₓ plus the offset V_{offset}_{_}₁ equals a dynamic threshold value of force sensing signal Vₜₕ_{_}ₓ.

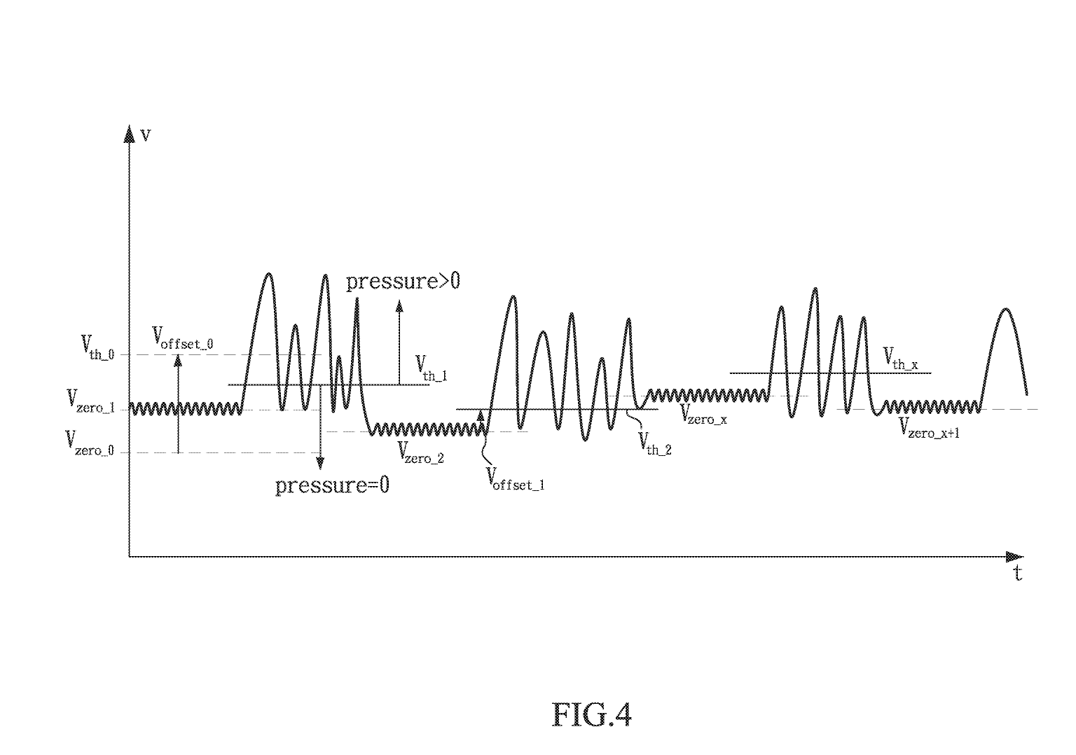

FIG. 4 shows a schematic diagram illustrating dynamically detecting threshold value of displaying stylus stroke according one embodiment of the invention. As show in FIG. 4, a default value of zero-force sensing signal V_{zero}_{_}₀ and a default offset V_{offset}_{_}₀ are predefined in a stylus. The default value of zero-force sensing signal V_{zero}_{_}₀ plus the default offset V_{offset}_{_}₀ equals a default threshold value of force sensing signal Vₜₕ_{_}₀ available to display stylus stoke on a touch panel. The default offset value V_{offset}_{_}₀ is set with a wide range enough to cover the variation of stylus in production and different operating environments.

Vₜₕ_{_}₀=V_{zero}_{_}₀+V_{offset}_{_}₀,

wherein V_{zero}_{_}₀ and V_{offset}_{_}₀ are pre-defined

During usage of the stylus, while the stylus is power-up, a step of detecting an average of sampling values Vₖ of legal zero-force sensing signal is performed. The sampling values Vₖ are smaller than the default threshold value of force sensing signal Vₜₕ_{_}₀. The sampling values Vₖ are within a standard deviation V_{dev}, that is

Vₖ<Vₜₕ_{_}₀

|Vₖ−Vₖ₋₁|<V_{dev}

If the average of sampling values Vₖ of legal zero-force sensing signal is generated and detected, the average is set as a new dynamic value of zero-force sensing signal V_{zero}_{_}₁. However, if the average of sampling values Vₖ of legal zero-force sensing signal is not generated and detected, the default value of zero-force sensing signal V_{zero}_{_}₀ remains as the value of zero-force sensing signal. It is noted that the default value of zero-force sensing signal V_{zero}_{_}₀ may be predetermined due to the specification of a stylus which is not actually being used yet before leaving the production line. Thus in production line of stylus under good control condition, a more realistic and reliable value of zero-force sensing signal V_{zero}_{_}₁ might be generated and detected and be encoded and written to on-chip non-volatile memory such as flash memory of a control unit of every stylus.

If the stylus is power-up again, the value of zero-force sensing signal V_{zero}_{_}₁ is read back from the on-chip non-volatile memory of the control unit of the stylus. Then, the value of zero-force sensing signal V_{zero}_{_}₁ plus an offset V_{offset}_{_}₁ obtains a threshold value of force sensing signal Vₜₕ_{_}₁ available and adaptive to display stylus stoke on a touch panel instead of the pre-defined default threshold value of force sensing signal Vₜₕ_{_}₀. The offset V_{offset}_{_}₁ is smaller than the default offset V_{offset}_{_}₀.

In one embodiment of the invention, before leaving production line, each stylus will have an optimal zero-force sensing signal value V_{zero} _{_}₁ stored in on-chip non-volatile memory of each stylus; Hence, with the same offset (V_{offset}_{_}₁), every stylus has its own optimal threshold value (Vₜₕ_{_}₁) after the stylus is power-up. The value of zero-force sensing signal V_{zero} _{_}₁ and the threshold value of force sensing signal Vₜₕ_{_}₁ can be obtained by the following equations,

V_{zero}_{_}₁=(Σₖ₌₀ⁿ⁻¹Vk)/n,

wherein n≧N, Vₖ<Vₜₕ_{_}₀, and |Vₖ−Vₖ₋₁|<V_{dev}

V_{zero}_{_}₁=V_{zero}_{_}₀,

wherein n<N

Vₜₕ_{_}₁=V_{zero}_{_}₁+V_{offset}_{_}₁,

wherein V_{offset}_{_}₁<V_{offset}_{_}₀

The value of zero-force sensing signal V_{zero}_{_}₁ is the average of the sum of sampling values Vₖ of legal zero-force sensing signal. The sampling values Vₖ are within a standard deviation V_{dev}. If n is smaller N, the default value of zero-force sensing signal V_{zero}_{_}₀ remains as the value of zero-force sensing signal, that is, V_{zero}_{_}₁ equals to V_{zero}_{_}₀. If V_{offset}_{_}₁ is smaller than V_{offset}_{_}₀, the value of zero-force sensing signal V_{zero}_{_}₁ plus an offset V_{offset}_{_}₁ equals a threshold value of force sensing signal Vₜₕ_{_{—1}}.

Next, based on a current threshold value, a step of detecting an average of sampling values Vₖ of legal zero-force sensing signal within a standard deviation V_{dev} is performed. The sampling values Vₖ are smaller than the threshold value of force sensing signal Vₜₕ_{_}₁. The sampling values Vₖ are within the standard deviation V_{dev}, that is

Vₖ<Vₜₕ_{_}₁

|Vₖ−Vₖ₋₁|<V_{dev}

If the average of sampling values Vₖ of legal zero-force sensing signal is generated and detected, the average is set as a new dynamic value of zero-force sensing signal V_{zero}_{_}₂. However, if the average of sampling values Vₖ of legal zero-force sensing signal is not generated and detected, the value of zero-force sensing signal V_{zero}_{_}₁ remains as the value of zero-force sensing signal. Then the new/old threshold value (Vₜₕ_{_}₂ or Vₜₕ_{_}₁) is available for following force sensing signal to display stylus stoke on a touch panel. The value of zero-force sensing signal V_{zero}_{_}₂ and the threshold value of force sensing signal Vₜₕ_{_}₂ can be obtained by the following equations.

V_{zero}_{_}₂=(Σₖ₌₀ⁿ⁻¹Vk)/n,

wherein n≧N, Vₖ<Vₜₕ_{_}₁, and |Vₖ−Vₖ₋₁|<V_{dev}

V_{zero}_{_}₂=V_{zero}_{_}₁, wherein n<N

Vₜₕ_{_}₂=V_{zero}_{_}₂+V_{offset}_{_}₁,

wherein V_{offset}_{_}₁<V_{offset}_{_}₀

With loopy detecting of sampling values Vₖ of legal zero-force sensing signal, a dynamic zero-force sensing signal value V_{zero}_{_}ₓ will be detected repeatedly. Then, the offset V_{offset}_{_}₁ plus the dynamic zero-force sensing signal value V_{zero}_{_}ₓ equals a dynamic threshold value Vₜₕ_{_}ₓ available for force sensing signal to display stylus stoke on a touch panel.

V_{zero}_{_}ₓ=(Σₖ₌₀ⁿ⁻¹Vk)/n,

wherein n≧N, Vₖ<Vₜₕ_{_}₁, and |Vₖ−Vₖ₋₁|<V_{dev}

V_{zero}_{_}ₓ=V_{zero}_{_}ₓ₋₁,

wherein n<N

Vₜₕ_{_}ₓ=V_{zero}_{_}ₓ+V_{offset}_{_}₁,

wherein V_{offset}_{_}₁<V_{offset}_{_}₀

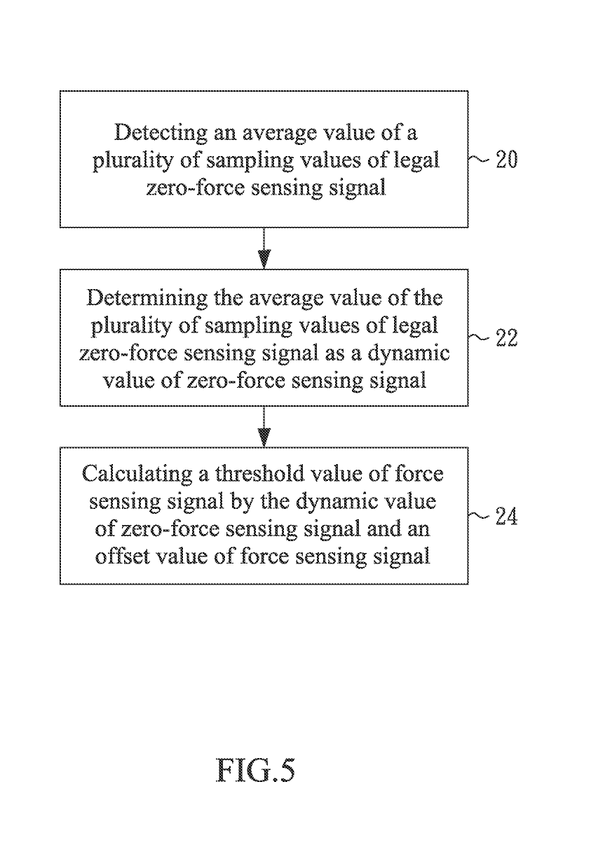

FIG. 5 shows a flow chart of method for dynamically detecting a threshold value of displaying stylus stroke on a touch panel according one embodiment of the invention. First of all, a step 20 of detecting an average value of a plurality of sampling values of legal zero-force sensing signal is performed. Then a step 22 of determining the average value of the plurality of sampling values of legal zero-force sensing signal as a dynamic value of zero-force sensing signal. Finally, a step 24 of calculating a threshold value of force sensing signal by the dynamic value of zero-force sensing signal and an offset value of force sensing signal. The method for dynamically detecting a threshold value of displaying stylus stroke on a touch panel can be performed by a program with executable instructions stored in a control unit with embedded non-transitory memory or computer readable medium.

Hence, a method for dynamically detecting a threshold value of displaying stylus stroke on a touch panel is performed. Since the threshold value of displaying stylus stroke on a touch panel can be dynamically detected and adjusted, the malfunction of stylus stroke including the stroke of the stylus displaying on the touch panel before the tip of the stylus contacts the touch panel or the thickness of the stroke displayed on the touch panel thinner than expected is avoided and the thickness of stylus stroke on a touch panel is well performed at the same time. Thus the invention provides a method for dynamically detecting a threshold value to compromise the above issues of displaying stylus stroke on a touch panel.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

What is claimed is:

1. A method for dynamically detecting a threshold value of force sensing signal for displaying stylus stroke on a touch panel comprising:
detecting an average value of a plurality of sampling values of legal zero-force sensing signal;
determining the average value of the plurality of sampling values of legal zero-force sensing signal as a dynamic value of zero-force sensing signal; and
calculating a threshold value of force sensing signal by the dynamic value of zero-force sensing signal and an offset value of force sensing signal.

2. The method according to claim 1, wherein the sampling values of legal zero-force sensing signal are within a standard deviation.

3. The method according to claim 1, wherein the dynamic value of zero-force sensing signal plus the offset value of force sensing signal equals the threshold value of force sensing signal. 4, The method according to claim 1, wherein the sampling values of legal zero-force sensing signal are smaller than a default threshold value of force sensing signal.

5. A stylus with functions of dynamically detecting a threshold value of force sensing signal for displaying stroke on a touch panel, comprising:
a control unit with embedded non-transitory computer readable medium storing executable instructions for performing a method for dynamically detecting a threshold value of force sensing signal for displaying stroke on a touch panel, comprising:
detecting an average value of a plurality of sampling values of legal zero-force sensing signal;
determining the average value of the plurality of sampling values of legal zero-force sensing signal as a dynamic value of zero-force sensing signal; and
calculating a threshold value of force sensing signal by the dynamic value of zero-force sensing signal and an offset value of force sensing signal.

6. The stylus according claim 5, wherein the dynamic value of zero-force sensing signal is larger than a default value of zero-force sensing signal.

7. The stylus according claim 5, wherein the offset value of force sensing signal is smaller than a default offset value of force sensing signal.

8. The stylus according claim 5, wherein the dynamic value of zero-force sensing signal plus the offset value of force sensing signal equals the threshold value of force sensing signal.

9. The stylus according claim 5, wherein the sampling values of legal zero-force sensing signal are smaller than a default threshold value of force sensing signal.
